(19) United States
(12) Patent Application Publication
(10) Pub. No.: US 2001/0027062 A1
(43) Pub. Date: Oct. 4, 2001

(54) Adapter for plug connectors

(76) Inventors: Andre Beneke, Langforden (DE); Sven Holtgrewe, Lubbecke (DE); Werner Jentzsch, Bad Oeynhausen (DE); Claus Kleedorfer, Rahden (DE)

Correspondence Address: Daniel C. McEachran, Cook, Alex, McFarron, Manzo, Cummings & Mehler Ltd., 200 West Adams Street - Suite 2850, Chicago, IL, 60606, US

(21) Appl. No.: 09/814,883

(22) Filed: Mar. 22, 2001

(30) Foreign Application Priority Data
Mar. 28, 2000 (DE) 200 05 860.6

(51) Int. Cl. H01R 25/00

(52) U.S. Cl. 439/638

(57) ABSTRACT

Adapter for connecting an office-network plug connector to an industrial plug connector, the said adapter having a casing (18, 20) which is provided with a mounting flange (22) which can be screwed to a switch-cabinet wall (26), for example, an office-network plug-connector part (10) and an industrial plug-connector part (14), the contacts of which are connected to one another.

The invention relates to an adapter for connecting an office-network plug connector to an industrial plug connector.

Network plug connectors which serve to connect, for example, computers to networks are known from office technology. Such plug connectors constitute proven, low-priced components. Also known are industrial plug connectors by means of which a reliable electrical connection is possible even in surroundings in which high demands are made on mechanical strength, resistance to environmental influences and imperviousness to dust and liquids and also on processability with ordinary industrial tools.

Very recently, classic network techniques from the world of office communications have been crowding into the industrial milieu to an increasing extent. This is aided by the availability of low-priced, proven hardware and software components. Because of the coalescing of networks and bus systems in the control and power sector, there is a need for the transmission of network signals in the industrial sector. However, the system cables designed for the office world are not suitable for the industrial sector, since they in no way meet the demands on a plug connection in respect of mechanical strength and also sealing.

The object of the invention therefore consists in making it possible to also use the proven, low-priced office-network plug connectors in conjunction with industrial plug connectors.

For this purpose there is provided, according to the invention, an adapter for connecting an office-network plug connector to an industrial plug connector, the said adapter having a casing which is provided with a mounting flange which can be screwed to a switch-cabinet wall, for example, an office-network plug-connector part and an industrial plug-connector part, the contacts of which are connected to one another. The said adapter ensures, in conjunction with, for example, a switch cabinet in which it is installed, that separation between the connection side of the industrial plug connector and the connection side of the office-network plug connector is guaranteed. Thus it is possible to use the comparatively delicate office-network plug connector on one side, that is to say in the interior of the switch cabinet, whereas the comparatively harsh conditions of the surroundings, which conditions require the use of a robust and sealed industrial plug connector, prevail on the other side, that is to say outside the said switch cabinet. Thus it is possible to have recourse, on both sides of the adapter, to the full product range of individual, proven plug connectors, a fact which leads to manifold possibilities as regards use.

Advantageous refinements of the invention emerge from the subclaims.

The invention will be described below with the aid of a preferred form of embodiment which is represented in the accompanying drawings, in which:

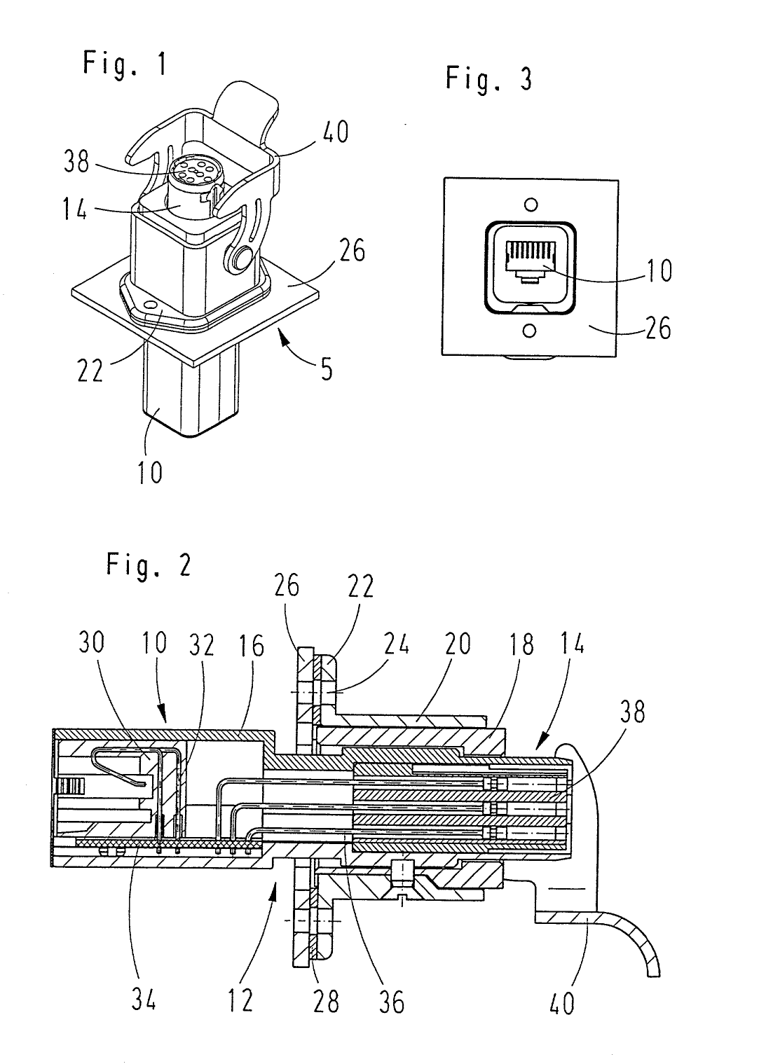

FIG. 1 shows a perspective view of an adapter according to the invention;

FIG. 2 shows a cross-sectional view through the adapter in FIG. 1; and

FIG. 3 shows a top view of that side of the adapter in FIG. 1 which is intended for the connection of the office-network plug connector.

The adapter 5 has an office-network plug-connector part 10 and also an industrial plug-connector part 14, whose contacts are connected to one another. An office-network plug connector which is complementary to the office-network plug-connector part can be plugged into the latter, whereas an industrial plug connector which is complementary to the industrial plug-connector part can be plugged into the latter.

The office-network plug-connector part 10 and the industrial plug-connector part 14 are connected to one another mechanically by a connecting piece 12. The said connecting piece 12 is part of a continuous screen 16 which extends from the office-network plug-connector part 10 as far as the industrial plug-connector part 14, so that screening of the cables belonging to the plug connectors plugged into the adapter is continued. The screen of the adapter is disposed in an inner casing part 18 which is surrounded by an outer casing part 20 which, in turn, is provided with a mounting flange 22. The said mounting flange 22 is provided with apertures 24 by means of which it can be fastened to a wall 26 which is represented only in the form of a cut-out portion here and may, for example, be the outer wall of a switch cabinet. For sealing purposes, a sealing rubber 28 is further disposed here between the wall 26 and that mounting face of the mounting flange 22 which faces towards the said wall. The mounting flange 22 lies on the outside of the switch cabinet, a fact which has the advantage that the opening in the wall of the said switch cabinet can turn out to be comparatively small, that is to say the office-network plug-connector part has smaller dimensions than the industrial plug-connector part.

The office-network plug-connector part has a spring-carrier 30 which is provided with contacts 32. The said contacts 32 are soldered into a circuit board 34 into which contacts 36 belonging to the industrial plug-connector part 14 are also soldered. The contacts 36 lead to a contact-carrier 38 which is disposed in the interior of the screen 16.

Disposed on the casing formed by the inner casing part and the outer casing part is a locking arrangement in the form of a locking lever 40 by means of which a complementary industrial plug connector can be locked on the adapter. The contact-carrier 38 is provided with a coding system, so that it is guaranteed that the complementary industrial plug connector can be plugged into the industrial plug-connector part only with the correct polarisation. A sealing system, for example a sealing ring, is also provided.

The adapter described makes it possible to use, on the inside of the switch cabinet, conventional, low-priced, proven office-network plug connectors, on which no special demands have to be made in respect of mechanical strength or sealing. There is then available on the outside of the switch cabinet, for connection in the industrial surroundings, an industrial plug connector which is suitably sealed and mechanically strong in view of the harsh conditions of the surroundings.

1. Adapter for connecting an office-network plug connector to an industrial plug connector, the said adapter having a casing (18,20) which is provided with a mounting flange (22) which can be screwed to a switch-cabinet wall (26), for example, an office-network plug-connector part (10) and an industrial plug-connector part (14), the contacts of which are connected to one another.

2. Adapter according to claim 1, characterized in that the casing has a locking arrangement (40) by means of which an industrial plug connector can be locked on the industrial plug-connector part (14).

3. Adapter according to claim 1, characterized in that a screen (16) is provided which extends from the office-network plug-connector part (10) as far as the industrial plug-connector part (14).

4. Adapter according to claim 3, characterized in that the screen (16) is electrically insulated from the casing (18, 20).

5. Adapter according to claim 1, characterized in that a coding system is provided which guarantees that the industrial plug connector can be plugged into the industrial plug-connector part (14) only with the correct polarization.

6. Adapter according to claim 1, characterized in that a mechanical sealing system is provided on the industrial plug-connector part (14).

7. Adapter according to claim 1, characterized in that a one-piece contact is provided for transmitting contact from the office-network plug-connector part (10) to the industrial plug-connector part (14).

8. Adapter according to claim 1, characterized in that a single line is provided for transmitting contact from the office-network plug-connector part (10) to the industrial plug-connector part (14).

9. Adapter according to claim 1, characterized in that a bus bar is provided for transmitting contact from the office-network plug-connector part (10) to the industrial plug-connector part (14).

10. Adapter according to claim 1, characterized in that a circuit board (34) is provided for transmitting contact from the office-network plug-connector part (10) to the industrial plug-connector part (14).

11. Adapter according to claim 1, characterized in that the mounting flange has a mounting face which faces towards the office-network plug-connector part (10).
